(19) United States
(12) Patent Application Publication
(10) Pub. No.: US 2012/0311476 A1
(43) Pub. Date: Dec. 6, 2012

(54) SYSTEM AND METHOD FOR PROVIDING AN ADAPTIVE TOUCH SCREEN KEYBOARD

(76) Inventor: ALAN STIRLING CAMPBELL, Lexington, KY (US)

(21) Appl. No.: 13/151,682

(22) Filed: Jun. 2, 2011

(51) Int. Cl. G06F 3/048

(52) U.S. Cl. 715/773

(57) ABSTRACT

A method for providing a touch screen keyboard according to one example embodiment includes detecting the presence of a user's fingers on a touch screen display. A set of home keys of a keyboard are associated with the detected fingers. The keyboard is displayed on the touch screen display with the home keys positioned at the locations of the detected fingers and additional keys positioned relative to the home keys.

### CROSS REFERENCES TO RELATED APPLICATIONS

This patent application is related to U.S. patent application Ser. No. ______, filed MONTH DAY, 2011, entitled “Method for Editing an Electronic Image on a Touch Screen Display” and assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present invention relates generally to a touch screen display and more particularly to a system and method for providing an adaptive touch screen keyboard.

2. Description of the Related Art

Touch screen displays, such as those utilized in a number of devices such as palmtops, tablet computers, mobile phones, and video game systems, incorporate a screen that is sensitive to external touch inputs provided either by touching the surface of the screen with one or more of a user's fingers or, in some devices, with a passive object such as a stylus. Various functions, such as typing, dialing a telephone number, clicking on or selecting a displayed item, are made by touching the surface of the screen.

Some touch screen displays include a virtual keyboard for typing purposes that includes a layout similar to that of a conventional mechanical keyboard. The virtual keyboard is arranged on the touch screen display in a static manner, i.e., the virtual keyboard is displayed in a fixed position on a predetermined portion of the touch screen display. Some devices allow the user to select between a virtual keyboard having a portrait orientation and one having a landscape orientation. The virtual keyboard includes a set of keys positioned at fixed locations and fixed distances from each other. The keys are arranged in rows along the keyboard and may include alphanumeric characters, punctuation marks, command keys, special characters and the like. The set of keys includes a subset identified as the home keys or the home row. Placement of the user's non-thumb fingers on the home keys generally permits the user to reach almost every other key on the keyboard. On a conventional QWERTY keyboard, the home keys include the following characters: “A”, “S”, “D”, “F”, “J”, “K”, “L”, and “;”.

To utilize the home keys while typing on a touch screen keyboard, a user first aligns his or her fingers across the home row just above the surface of the touch screen display. To enter a key on the home row, the user touches the desired key. Similarly, to enter a key not on the home row, the user extends his or her nearest finger from its home row position to the desired key. After entering the desired key, the user returns his or her finger to its previous position above the associated home key. Touch typing in this manner is efficient in that all of the user's fingers can be used in the typing process. However, because of the static arrangement of the keys, the user must adapt his or her hands to the layout of the virtual keyboard. This may cause stress or strain on the user's fingers and/or wrist which can lead to medical conditions such as carpal tunnel syndrome. Accordingly, it will be appreciated that a touch screen keyboard that adapts its layout to the user rather than requiring the user to adapt to the layout of the device is desired. Further, a method for entering characters or otherwise editing an electronic image on a touch screen display in addition to or in place of a keyboard may also be desired.

### SUMMARY

A method for providing a touch screen keyboard according to one example embodiment includes detecting the presence of a user's fingers on a touch screen display. A set of home keys of a keyboard are associated with the detected fingers. The keyboard is displayed on the touch screen display with the home keys positioned at the locations of the detected fingers and additional keys positioned relative to the home keys.

A computing system according to one example embodiment includes a touch screen display for receiving touch inputs from a user and displaying images thereon. At least one processor is communicatively coupled to said touch screen display. The computing system includes memory having computer executable program instructions stored therein to be executed by the processor. The computer executable program instructions include instructions for detecting the presence of the user's fingers on the touch screen display, instructions for associating a set of home keys of a keyboard with the detected fingers, and instructions for displaying the keyboard on the touch screen display with the home keys positioned at the locations of the detected fingers and additional keys positioned relative to the home keys.

According to another example embodiment, a non-transitory computer readable storage medium has computer executable program instructions which, when executed by a computing system having a touch screen display, cause the system to detect the presence of a user's fingers on the touch screen display, associate a set of home keys of a keyboard with the detected fingers, and display the keyboard on the touch screen display with the home keys positioned at the locations of the detected fingers and additional keys positioned relative to the home keys.

### BRIEF DESCRIPTION OF THE DRAWINGS

The above-mentioned and other features and advantages of the various embodiments, and the manner of attaining them, will become more apparent and will be better understood by reference to the accompanying drawings.

FIG. 1 is a block diagram of a computing system having a touch screen display according to one example embodiment.

FIG. 2 is a flowchart of a method for providing a touch screen keyboard according to one example embodiment.

FIG. 3 is a schematic diagram of a touch screen display according to one example embodiment showing a user's fingers placed thereon.

FIG. 4 is a schematic diagram of a touch screen display having an adaptive keyboard displayed at a first position thereon according to one example embodiment.

FIG. 5 is a schematic diagram of a touch screen display having an adaptive keyboard displayed at a second position thereon according to one example embodiment.

FIG. 6 is a schematic diagram of a touch screen display having an adaptive keyboard displayed at a third position thereon according to one example embodiment.

FIG. 7 is a schematic diagram of a touch screen display having an adaptive keyboard of a first size displayed thereon according to one example embodiment.

FIG. 8 is a schematic diagram of a touch screen display having an adaptive keyboard of a second size displayed thereon according to one example embodiment.

FIG. 9 is a schematic diagram of a touch screen display having an adaptive keyboard transparently overlaid on an electronic image being edited according to one example embodiment.

FIG. 10 is a schematic diagram illustrating various swipe movements for deactivating a keyboard displayed on a touch screen display according to one example embodiment.

FIG. 11 is a flowchart of a method for editing an electronic image on a touch screen display according to one example embodiment.

FIG. 12 illustrates successive finger movements in the form of a swipe on a touch screen display for entering a symbol according to one example embodiment.

FIG. 13 illustrates a series of finger movements in the form of swipes on a touch screen display for entering an equation according to one example embodiment.

### DETAILED DESCRIPTION

The following description and drawings illustrate embodiments sufficiently to enable those skilled in the art to practice the present invention. It is to be understood that the disclosure is not limited to the details of construction and the arrangement of components set forth in the following description or illustrated in the drawings. The invention is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present invention is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

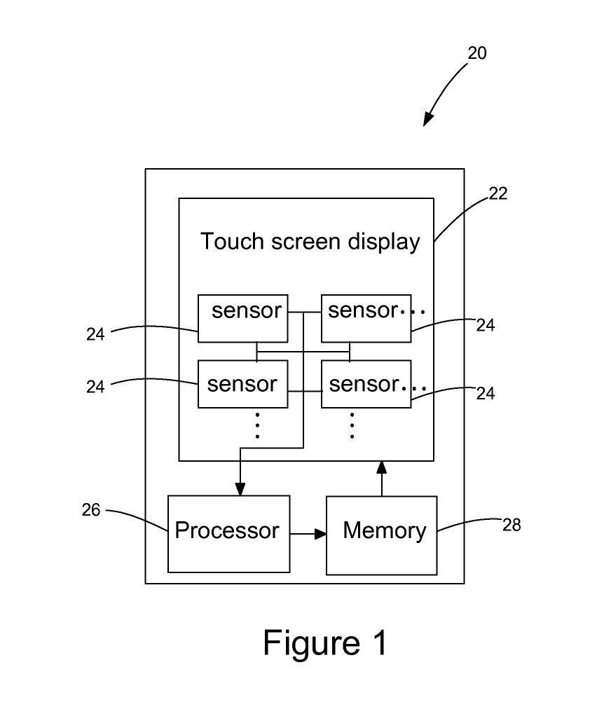

FIG. 1 illustrates a block diagram of a computing system 20 according to one example embodiment. Computing system 20 includes a touch screen display 22 that is sensitive to external contacts provided on its surface such as touch inputs from a user's finger(s) or, in some embodiments, an input device such as a stylus. Touch screen display 22 is configured to detect the presence and location of at least ten simultaneous touch inputs thereon. A touch input may be detected when a finger or other input device makes physical contact with or, in some embodiments, is within close proximity to touch screen display 22. Computing system 20 may be any system utilizing a touch screen display such as, for example a palmtop, tablet computer, mobile phone or a video game system.

Touch screen display 22 may employ any suitable multipoint technology known in the art, such as a resistive touch screen panel, a capacitive touch screen panel (e.g., surface capacitance or projected capacitance), surface acoustic wave technology or the like, to recognize multiple touch inputs. However, the specific type of the multipoint technology employed by touch screen display 22 is not intended to be limiting. Computing system 20 may include a plurality of sensors 24 that are operatively coupled to touch screen display 22 to sense the touch inputs received thereon and generate signals corresponding to the presence and locations of the touch inputs.

Touch screen display 22 is also able to display an image including characters, graphics or the like that is in sufficient resolution to provide the user with clear visibility of its contents as is known in the art. The size of touch screen display 22 is sufficient to accommodate a plurality of simultaneous touch inputs. In the example embodiment illustrated, touch screen display 22 is depicted as rectangular in shape; however, any suitable shape may be used as desired.

Computing system 20 also includes one or more processors 26 communicatively coupled to touch screen display 22. Processor 26 includes or is communicatively coupled to a computer readable storage medium such as memory 28 having computer executable program instructions which, when executed by processor 26, cause processor 26 to perform the steps described herein. Memory 28 may include read-only memory (ROM), random access memory (RAM), non-volatile RAM (NVRAM), optical media, magnetic media, semiconductor memory devices, flash memory devices, mass data storage device (e.g., a hard drive, CD-ROM and/or DVD units) and/or other storage as is known in the art. Processor 26 executes the program instructions to interpret data received from sensors 24 and/or touch screen display 22 to detect the presence and location of the touch inputs on touch screen display 22. The one or more processors 26 also execute program instructions to control the operation of the graphical display portion of touch screen display 22 to display an electronic image thereon. Processor 26 may include one or more general or special purpose microprocessors, or any one or more processors of any kind of digital computer. Alternatives include those wherein all or a portion of processor 26 is implemented by an application-specific integrated circuit (ASIC) or another dedicated hardware component as is known in the art.

Processor 26 is programmed to distinguish between various types of touch inputs. For example, processor 26 is able to distinguish a single, brief, substantially stationary touch input on touch screen display 22 in the form of a “tap” from a more continuous, substantially stationary touch input on touch screen display 22. Processor 26 is also able to distinguish a substantially stationary touch input from a moving touch input in the form of a moving presence or “swipe.” If the location of the touch input on the surface of touch screen display 22 changes substantially over a predetermined time period, the touch input is interpreted as a swipe. If the location of the touch input on touch screen display 22 is substantially constant over the predetermined time period, the duration of the presence of the touch input is measured to determine whether it is a tap or a more continuous, resting presence. Processor 26 is able to detect a sequence of multiple touch inputs and determine their relative locations.

In one example embodiment, once the presence of a touch input is detected on the surface of touch screen display 22, the location of the touch input is read by processor 26 at fixed intervals, such as, for example every ten milliseconds (ms). If the location of the touch input does not change by more than a small amount, such as, for example one millimeter (mm), and the presence of the touch input is no longer detected after a predetermined amount of time, such as, for example 200 ms, then the touch input is interpreted as a tap. If the location of the touch input does not change by more than a small amount, such as, for example one millimeter, during a predetermined time period, such as, for example the next 500 ms, but the presence of the touch input is detected for the entire time to period, then the touch input is interpreted as a resting presence. Conversely, if the location of the touch input changes by more than a small amount, such as, for example one millimeter, during the next consecutive intervals, then the touch input is interpreted as a swipe. These distances and time limits are provided merely as an example and are not intended to be limiting.

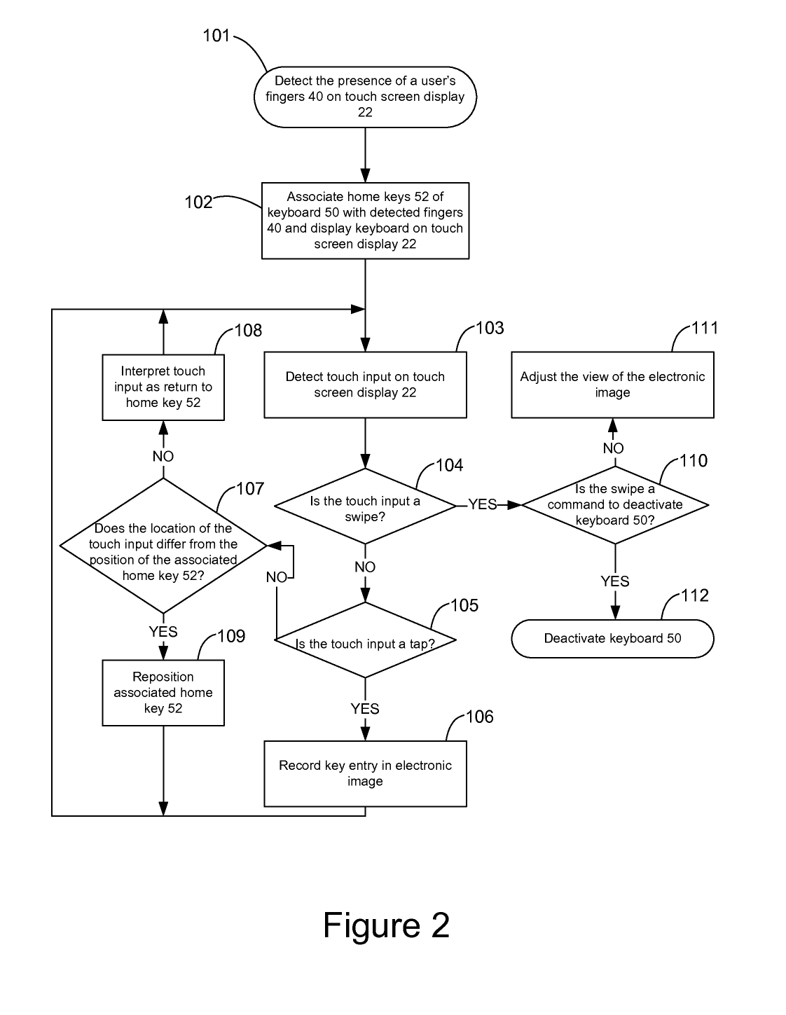

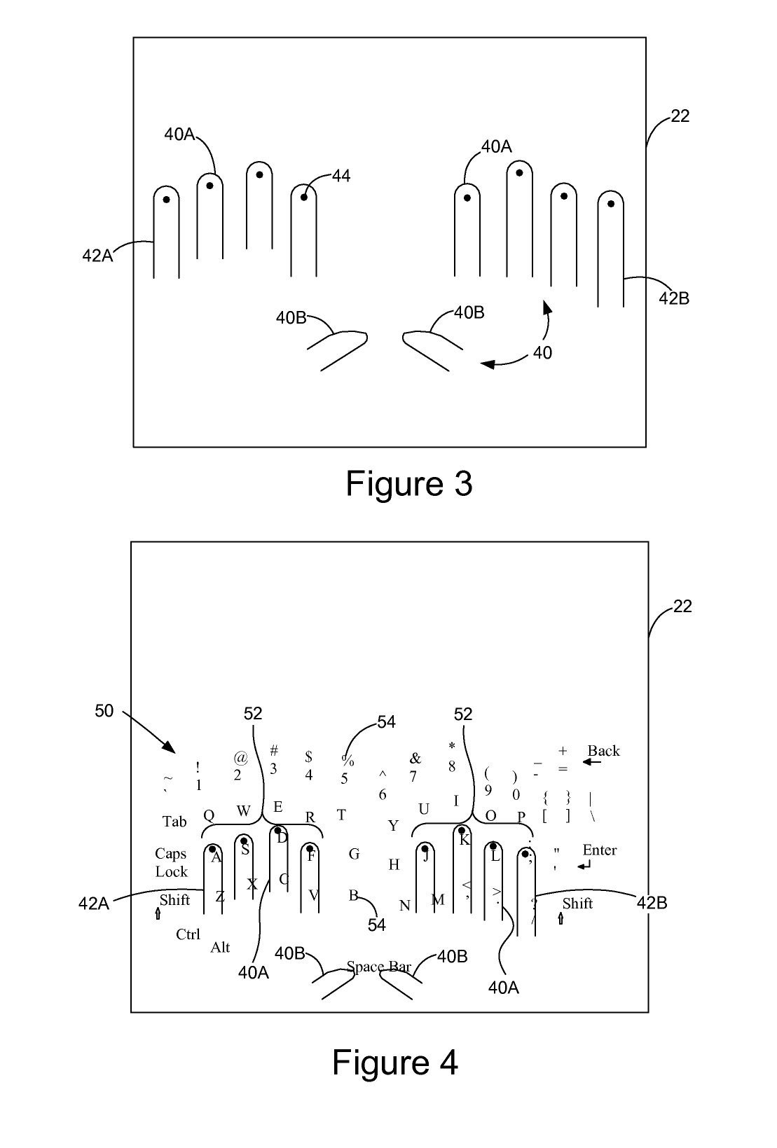

FIG. 2 illustrates a flowchart of a method for providing a touch screen keyboard according to one example embodiment. At step 101, a keyboard mode is initiated upon the detection of a user's fingers 40 on touch screen display 22. In one example embodiment, at least seven of the user's fingers 40 must be detected on touch screen display 22 in order to properly locate the home keys of the keyboard and initiate keyboard mode. In FIG. 3, both hands 42A, 42B of the user are illustrated with each of the eight non-thumb fingers 40A providing a touch input on touch screen display 22, represented for purposes of illustration by black dots 44 at the tip of each non-thumb finger 40A. The user's thumbs 40B are also illustrated not in contact with touch screen display 22. Processor 26 is able to distinguish between the non-thumbs 40A and thumb 40B of a given hand 42 and between the user's left hand 42A and right hand 42B by measuring the relative displacement between the various touch inputs formed by the user.

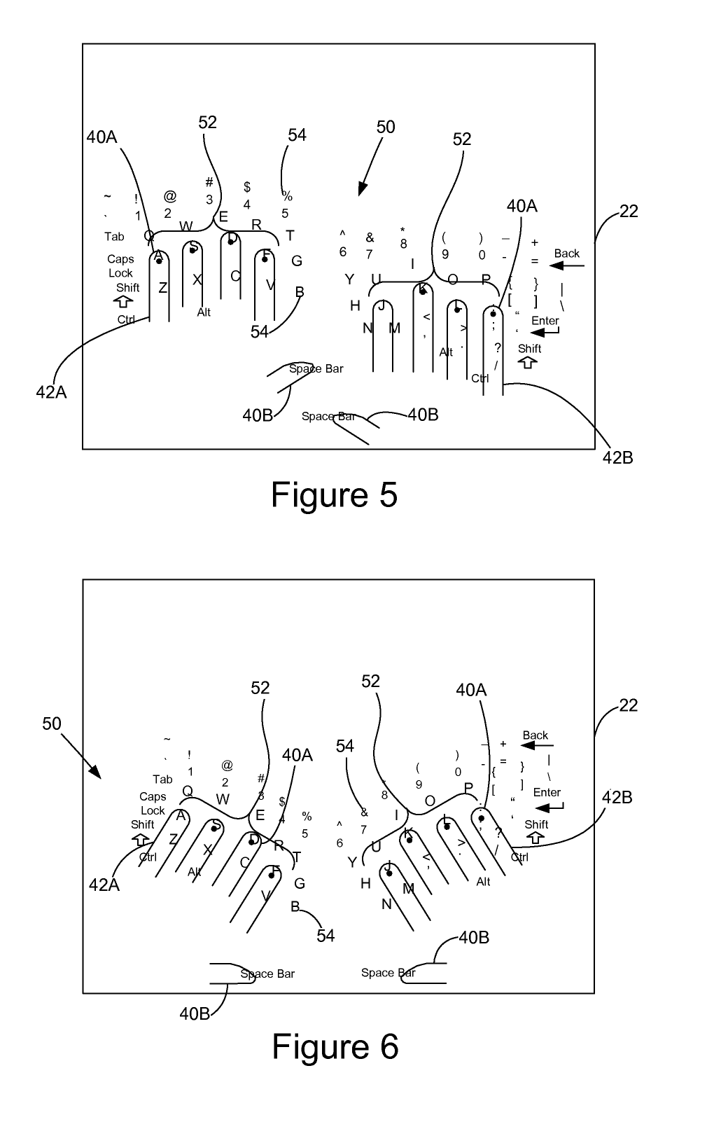

At step 102, a set of home keys 52 of a keyboard 50 are associated with the detected fingers 40 and keyboard 50 is displayed on touch screen display 22 as shown in FIG. 4. Keyboard 50 includes various key icons, much like a conventional mechanical keyboard, that represent the positions of the various keys of keyboard 50. Among the key icons are home keys 52 and additional keys 54. In the conventional QWERTY format, home keys 52 include the following characters: “A”, “S”, “D”, “F”, “J”, “K”, “L”, and “;”. Home keys 52 are adaptively positioned at the detected locations of non-thumb fingers 40A. In other words, the positions of home keys 52 are determined by the placement of non-thumb fingers 40A. FIG. 4 illustrates a first configuration of home keys 52. As illustrated, each home key 52 is positioned at the location of one of the user's non-thumb fingers 40A. FIG. 5 illustrates a second configuration where the user's left hand 42A is placed higher on touch screen display 22 than his or her right hand 42B. As a result, the home keys “A”, “S”, “D” and “F” are positioned higher on keyboard 50 than the home keys “J”, “K”, “L”, and “;”. Similarly, FIG. 6 illustrates a third configuration where the user's hands 42A, 42B are rotated inward toward each other. As a result, home keys 52 also include this rotation and are positioned at the locations of the user's non-thumb fingers 40A.

With continued reference to FIGS. 4-6, the positions of additional keys 54 are defined with respect to the positions of home keys 52. Additional keys 54 include all keys other than home keys 52. In one embodiment, each additional key 54 is spaced by a fixed, predetermined distance from a corresponding home key 52. In this embodiment, the direction each additional key 54 is spaced from its corresponding home key 52 is defined by the alignment of the corresponding hand 42. For example, where the non-thumb fingers 40A of the user's hand 42 are aligned substantially horizontal across touch screen display 22, additional keys 54 will be spaced substantially vertically from their corresponding home keys 52 as shown in FIG. 4. In contrast, where the user's hands 42A, 42B are rotated inward toward each other, additional keys 54 will be spaced from their corresponding home keys 52 at an angle as shown in FIG. 6. In another embodiment, the spacing between additional keys 54 and home keys 52 depends on the spacing between non-thumb fingers 40A and, in turn, the spacing between home keys 52. For example, in this embodiment, if one user's non-thumb fingers 40A are spaced closer together than another's, additional keys 54 will be positioned closer to home keys 52 for the first user than they will for the second.

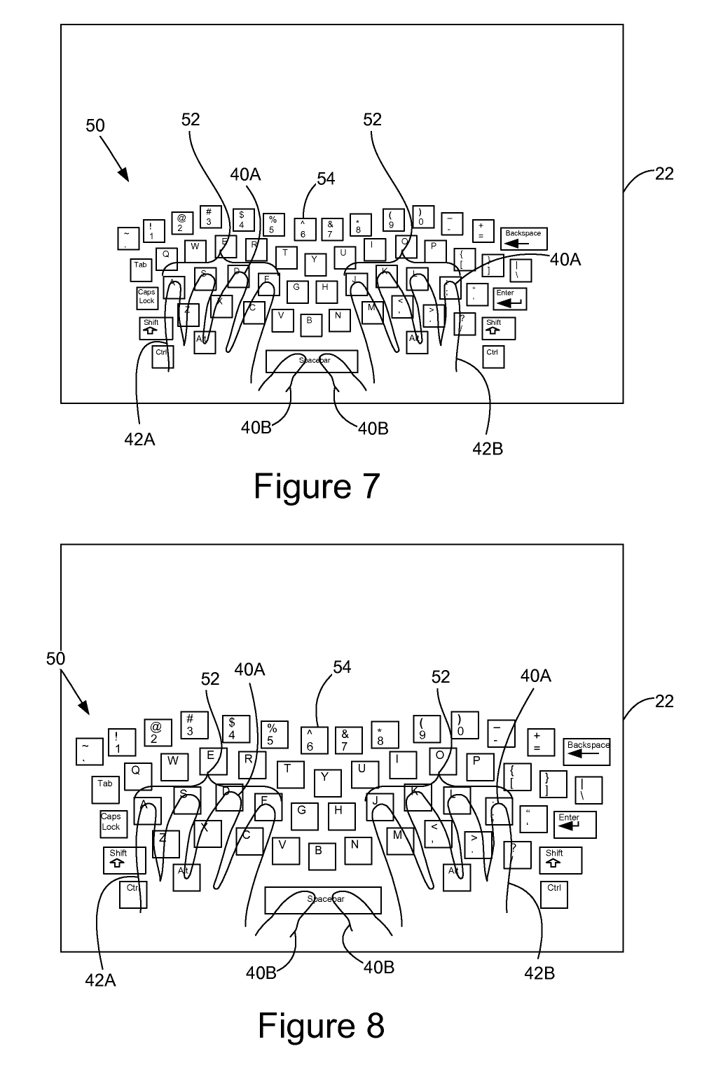

With reference to FIGS. 7 and 8, in an additional embodiment, the size of keys 52, 54 depends on the spacing between non-thumb fingers 40A and, in turn, the spacing between home keys 52. The spacing between a user's non-thumb fingers 40A provides an indication of the size of the user's hands. As shown in FIG. 7, where the spacing between a first user's non-thumb fingers 40A is relatively small, processor may provide smaller keys 52, 54 causing keyboard 50 to occupy less space on touch screen display 22 in order to accommodate the first user's relatively small hands. In contrast, as shown in FIG. 8, where the spacing between a second user's non-thumb fingers 40A is relatively large, processor may provide larger keys 52, 54 causing keyboard 50 to occupy more space on touch screen display 22 in order to accommodate the second user's relatively large hands.

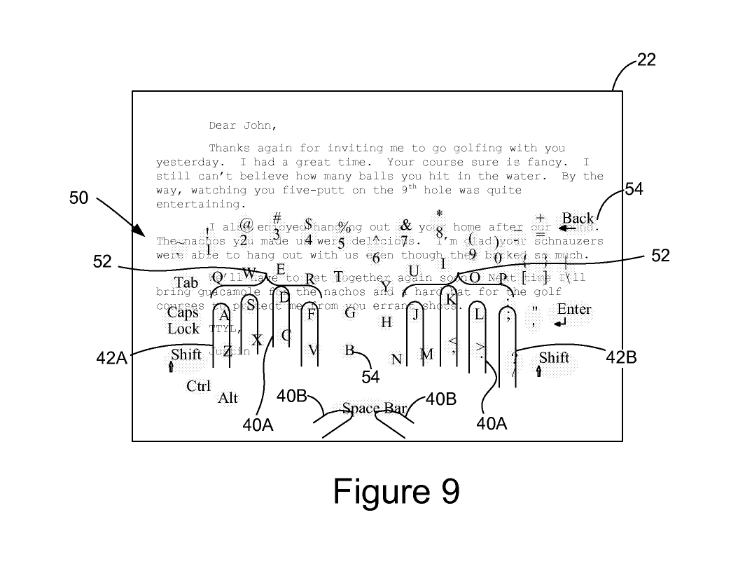

With reference back to FIG. 4, the displayed icons of keys 52, 54 of keyboard 50 include a symbol representing the key's function. In other embodiments, the icons of keys 52, 54 also include a border around each key (FIGS. 7 and 8). In one embodiment, the display of keyboard 50 is transparently overlaid on an electronic image being edited to provide a relatively clear view of the electronic image under keyboard 50 as illustrated in FIG. 9. The electronic image may include any type of editable electronic document, database or graphic such as, for example a word processing document, a spreadsheet, a photograph, a picture or drawing, an email, a text message, a database of personal contacts, an internet browser, a PDF file, or a video game interface. In other embodiments, keyboard 50 occupies a first portion of touch screen display 22 and the electronic image either occupies a second portion of touch screen display 22 or appears on a second display. In one embodiment, the key icons adjust to match one or more of a font type (e.g., Times New Roman, Courier, etc.) a font style (e.g., bold, underlined, italics, etc.) and a font color selected by the user for use in the electronic image being edited.

At step 103, processor 26 detects a touch input on touch screen display 22. When a touch input is detected, processor 26 determines whether the touch input is a swipe at step 104. If the touch input is not a swipe, at step 105, processor 26 determines whether the touch input is a tap. If the touch input detected is a tap and the tap is located on keyboard 50, processor 26 interprets the tap as a key stroke and records a key entry in the electronic image being edited. Accordingly, the user may enter a string of characters in the electronic image by successively tapping on keys 52, 54.

If the detected touch input is not a tap, at step 107, processor 26 determines whether the user's finger 40 has returned to its respective home key 52 or whether the finger 40 is located at a new position. If the location of the touch input is at the home key 52, processor 26 interprets the touch input as a return to the home key 52 and does not record a key entry at step 108. In this manner, processor 26 is able to distinguish a key entry of a home key 52 from a return to the home row. This allows the user to rest his or her fingers on the home row without causing unwanted key strokes. At step 109, if the location of the touch input is not at the position of the home key 52, processor 26 repositions the respective home key 52 to the location of the user's finger. In one example embodiment, in order to reposition home keys 52, at least seven of the user's fingers 40 must be detected on touch screen display 22 in order to properly locate home keys 52. In this manner, the layout of keyboard 50 continues to adapt to the user's hands even after the initial arrangement of keyboard 50 at step 102. Processor 26 may also distinguish between a swipe and a mere drifting of the user's fingers 40. In the case of drifting of the user's fingers, home keys 52 are repositioned to remain aligned with the user's fingers 40. As a result, in contrast to conventional keyboards that force the user to adjust to the layout of the keyboard, keyboard 50 allows the user to position his or her fingers 40 on keyboard 50 according to his or her own comfort level.

When performing a typing operation with his or her fingers positioned on the home row, the user is able to perform a key stroke on one of home keys 52 by lifting his or her finger off the desired home key 52 and then tapping the desired home key 52. Similarly, in order to perform a key stroke on one of the additional keys 54, the user is able to lift his or her finger from its home key 52 and then tap the desired additional key 54. In some embodiments, processor 26 identifies a key stroke of one of additional keys 54 by detecting both the location of the touch input on the additional key 54 and the removal of one of the user's fingers 40 from its respective home key 52. In this manner, the identification of the additional key 54 may be based on the relative location of the touch input with respect to the home row locations as well as the loss of contact of a finger 40 from the home row. Additional embodiments also measure the time elapsed between the removal of the finger 40 from its respective home key 52 to aid in determining which additional key 54 has been struck. However, after performing a key stroke on an additional key 54, the user is not required to return to the home position prior to entering another additional key 54. Rather, processor 26 analyzes the sequence of successive touch inputs to determine the key strokes. For example, in typing the word “great”, the home row finger that leaves the “f” key may be used to select the “g”, “r” and “t” keys before returning to the “f” key. As a result, the user is able to type a document according to his or her normal typing habits. In one embodiment, a mode may be provided in which the key icons are hidden but key entries are still recorded according to the home key 52 positions established by the user's fingers 40. The mode may be triggered by a user input or it may occur automatically upon the occurrence of a predetermined condition such as, for example detecting the entry of a predetermined number of successive key strokes or detecting that typing has commenced after keyboard mode has been activated. This provides a clearer view of the electronic image being edited and may be particularly useful to experienced typists.

In one embodiment, the positions of additional keys 54 are updated dynamically based on the detection of corrections performed by the user. Each time a character that has been entered into the electronic image is subsequently replaced by the user, processor 26 monitors whether the correction resulted from a typing error on the part of the user, e.g., a misspelling by the user, or confusion over where one of the additional keys 54 is located. Processor 26 observes whether a key entry of a first additional key 54, e.g., “r”, is replaced with a second additional key 54 that abuts the first additional key 54, e.g., “e”. Over time, if it appears this correction is performed on a recurring basis, processor 26 adjusts the position of at least one of the first and second additional keys 54 so that the position of the second additional key 54, in this case “e”, corresponds with the location of the touch input being corrected. The adjusted positions may then be associated with a user profile for a specific user and stored in memory 28.

In another embodiment, the user can train computing system 20 to recognize his or her typing preferences by entering a training mode in which computing system 20 instructs the user to perform a predetermined sequence of key strokes on keyboard 50 such as, for example typing a phrase like “the quick brown fox jumps over the lazy dog” several times on touch screen display 22. Processor 26 then detects the locations of the performed key strokes and adjusts the positions of additional keys 54 based on the detected locations. The adjusted positions may then be associated with the user profile in memory 28. In this manner, processor 26 is able to learn the locations of additional keys 54 relative to home keys 52 for the user and adapt the layout of keyboard 50 accordingly.

In some embodiments, at least one of an audible feedback, a visual feedback and a haptic feedback is provided to the user when a touch input is detected. Audio feedback may be particularly useful to assist a visually impaired user. For example, after each key entry, an audible feedback may be provided to indicate the key typed. Further, a spacebar may be used to initiate speech feedback of the last character or word typed. Other keyboard input may be used to initiate a spoken report of a desired sentence, paragraph, page, etc. that was typed.

Computing system 20 may also utilize swipe inputs to permit the user to adjust the view of the electronic image or to deactivate keyboard mode and remove the display of keyboard 50 from touch screen display 22. At step 110, if the detected touch input is a swipe, processor 26 determines whether the swipe is a command to deactivate keyboard mode. If the touch input is not a command to deactivate keyboard mode, at step 111, various different swipe patterns may permit the user to adjust the view of the electronic image. For example, a simultaneous swipe of both of the user's thumbs 40B may be used to provide a zoom function. A swipe by one of the fingers 40 on the user's right hand 42B may be used to pan up, down, left or right within the electronic image in order to view a different portion of the image. Further, a swipe by one of the fingers 40 on the user's left hand 42A may be used to move the location of a cursor in the electronic image that defines the location where the next action of keyboard 50 will be applied.

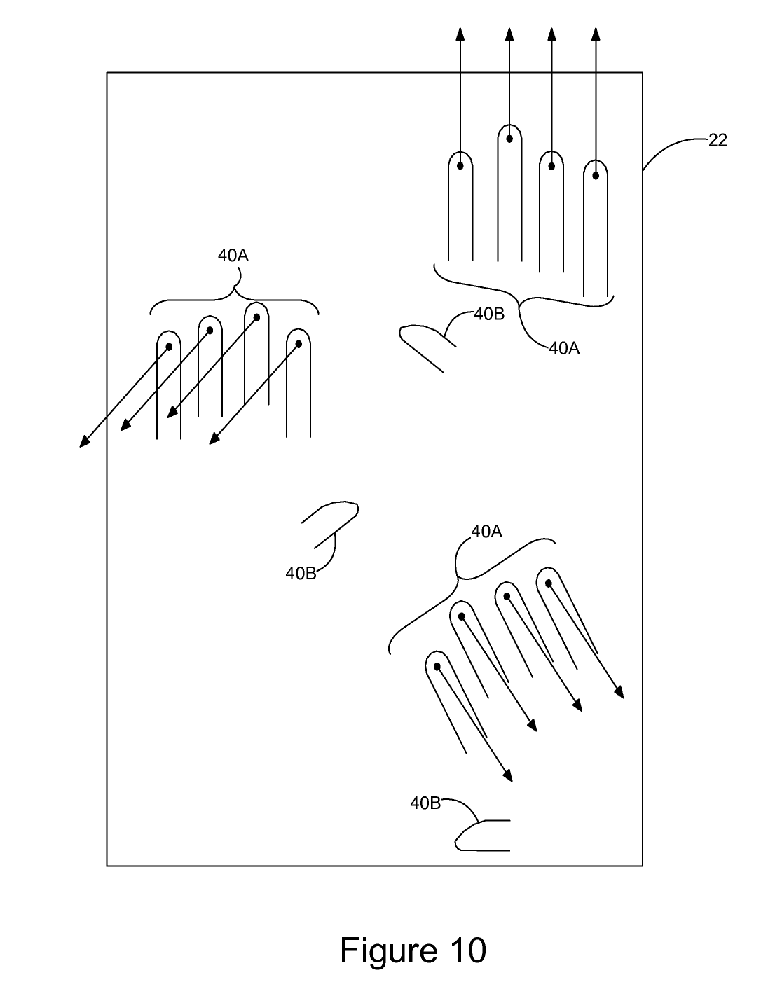

In one embodiment, a predetermined swipe pattern permits the user to deactivate keyboard mode and remove keyboard 50 at step 112. For example, as illustrated in FIG. 10, a swipe by a predetermined number of the non-thumb fingers 40A of either of the user's hands 42A, 42B across and off touch screen display 22 may be used to deactivate keyboard mode. In the example embodiment illustrated, four of the user's non-thumb fingers 40A are used to deactivate keyboard mode. Non-thumb fingers 40A may be swiped or dragged in any direction as shown by the arrows in FIG. 10.

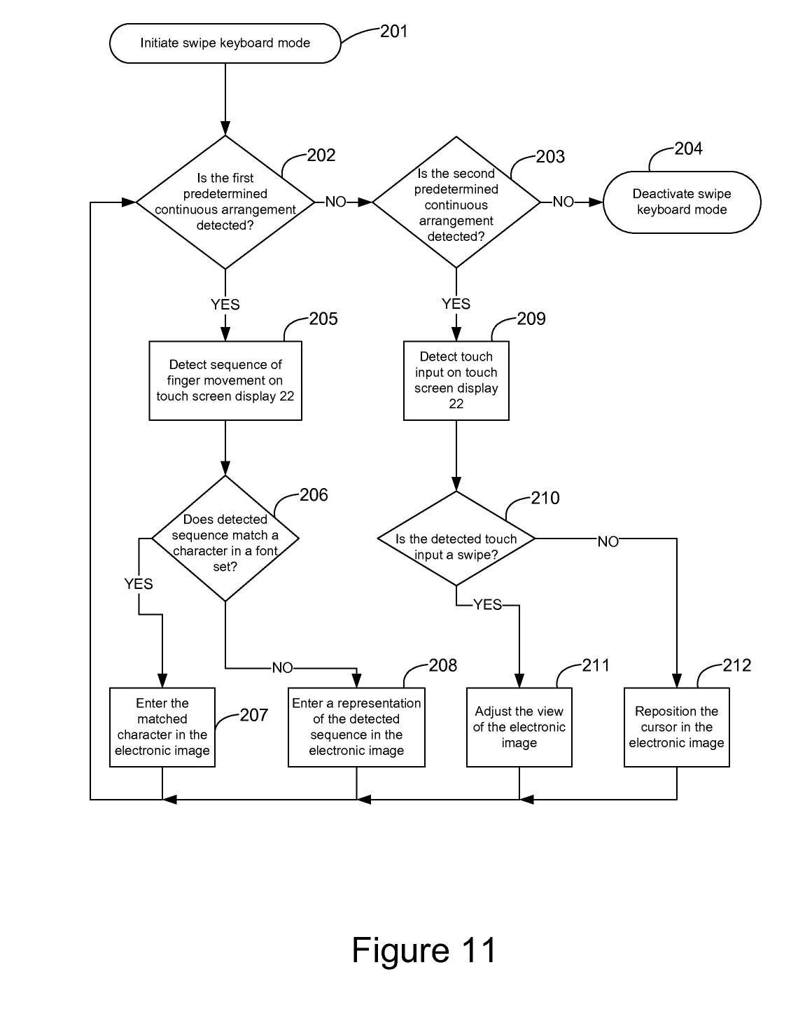

FIG. 11 illustrates a flowchart of a method for editing an electronic image on a touch screen display, such as touch screen display 22. The method depicted in FIG. 11 may be implemented along with the adaptive keyboard 50 discussed in conjunction with FIGS. 2-10 or on a standalone basis. The method includes a swipe keyboard mode that permits the user to enter characters or graphics in the electronic image by drawing the characters or graphics using swipes on touch screen display 22. At step 201, the swipe keyboard mode is initiated. In one embodiment, swipe keyboard mode is initiated when the user places one of his hands 42A, 42B on touch screen display 22 according to at least one predetermined continuous finger arrangement. The predetermined continuous finger arrangement includes the placement of a specific set of the user's fingers on touch screen display 22 in a substantially stationary manner. Where swipe keyboard mode is utilized in conjunction with adaptive keyboard 50, the number of fingers required to form the predetermined continuous finger arrangement is less than the predetermined number of fingers required to display keyboard 50. In one example embodiment, the first predetermined continuous finger arrangement consists of the substantially stationary presence of two non-thumb fingers 40A of one of the user's hands 42A, 42B on touch screen display 22 and the second predetermined continuous finger arrangement consists of the substantially stationary presence of two non-thumb fingers 40A and the thumb 40B of one of the user's hands 42A, 42B on touch screen display 22. Swipe keyboard mode remains active as long as processor 26 detects the presence of one of the predetermined finger arrangements.

In the example embodiment illustrated, processor 26 monitors for the presence of either of a first or a second predetermined continuous finger arrangement. If neither is detected, swipe keyboard mode is deactivated. Specifically, at step 202, processor 26 determines whether the first predetermined continuous finger arrangement is detected. If the first predetermined continuous finger arrangement is not detected, processor 26 determines whether the second predetermined continuous finger arrangement is detected at step 203. If the second predetermined continuous finger arrangement is not detected, swipe keyboard mode is deactivated at step 204. When the swipe keyboard mode is deactivated, computing system 20 returns to its previous mode of operation. For example, if keyboard mode was active prior to activating swipe keyboard mode, when swipe keyboard mode is deactivated, computing system 20 will return to keyboard mode.

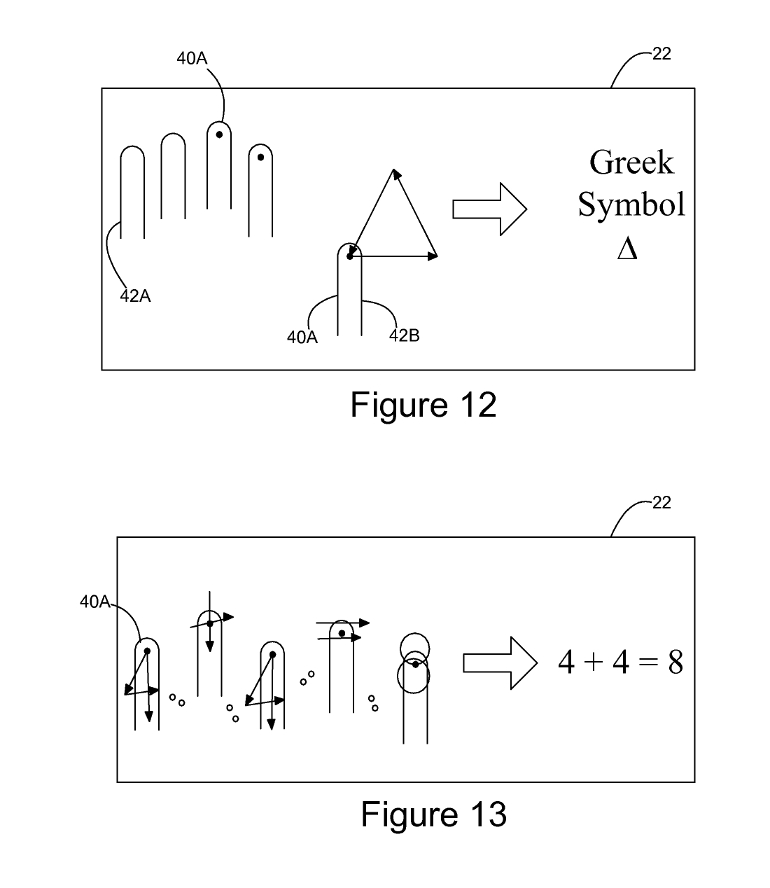

While the user applies the first predetermined continuous finger arrangement on touch screen display 22, he or she may manually enter a character or marking in the electronic image being edited by performing a series of finger movements on touch screen display 22 to draw the character or marking. Processor 26 interprets the finger movements and enters the interpretation in the electronic image. In one embodiment, after processor 26 detects the sequence of finger movement at step 205, processor 26 then determines whether the detected sequence of finger movement matches one of the characters in a font set at step 206. In one embodiment, the font set includes the current selected font set as well as common symbols such as, for example mathematic symbols, Greek symbols, Kanji characters or the like. If the detected sequence of movement matches one of the characters in the font set, processor 26 then enters the character in the electronic image at step 207. For example, in FIG. 12, the user's left hand 42A provides the first predetermined continuous finger arrangement while the user's right hand 42B draws the Greek symbol delta (A). Processor 26 determines that the user has entered the delta symbol and records it in the electronic image.

In one embodiment, processor 26 waits until it receives a predetermined input from the user signaling that the swipe entry is complete before it determines whether the detected sequence of finger movement matches one of the characters in the font set. For example, where the first predetermined continuous finger arrangement consists of the substantially stationary presence of two non-thumb fingers 40A of one of the user's hands 42 on touch screen display 22, processor 26 waits until the user taps the thumb 40B of the hand 42 forming the first predetermined continuous finger arrangement before it determines whether the detected sequence of finger movement matches one of the characters in the font set.

FIG. 13 illustrates this sequence. The user first draws the number four (4) on touch screen display 22. The user then taps his thumb, indicated by the small circle shown in FIG. 13. At this point, processor 26 analyzes the user's input and recognizes that the user has drawn the number four. Accordingly, the number four is recorded in the electronic image. The user then taps his thumb again; since no swipe is detected, a space is recorded in the electronic image. The user then draws the plus symbol (+) followed by a pair of thumb taps. As a result, the plus symbol and a space are recorded in the electronic image. The user then draws the number four once again followed by a pair of thumb taps which results in the number four and a space being recorded in the electronic image. The user then draws the equal sign (=) followed by two thumb taps which results in the equal sign and a space being recorded in the electronic image. The user then enters the number eight (8) and the number eight is recorded in the electronic image. Accordingly, the user has drawn, using swipe movements on touch screen display, the equation 4+4=8 and this equation has been recognized by processor 26 and recorded in the electronic image. In an alternative embodiment, processor 26 is further programmed to recognize the entry of an equation by the user and calculate and record the answer to the equation for the user like a calculator. In this alternative, when the user entered “4+4=”, processor 26 would have recognized the entry of an equation and calculated the sum of four plus four. Processor 26 would then record the sum, eight, in the electronic image.

In swipe keyboard mode, the user may enter a backspace by entering a predetermined touch input on touch screen display 22. For example, where the first predetermined continuous finger arrangement consists of the substantially stationary presence of two non-thumb fingers 40A of one of the user's hands 42A, 42B on touch screen display 22, the user may enter a backspace by tapping a third non-thumb finger 40A of the hand 42 forming the first predetermined continuous finger arrangement.

If the sequence of movement detected at step 206 does not match one of the characters in the font set, processor 26 enters a representation of the detected sequence of finger movement in the electronic image at step 208. The representation may be overlaid on the contents of the electronic image in the form of a markup or it may be inserted into the contents of the electronic image at the cursor position. For example, the user may wish to mark up a document by circling, underlining or crossing out specific words in the electronic image. Alternatively, the user may wish to enter a custom image such as his or her signature at the cursor position. In order to determine whether to record the representation as a markup or an insert, processor 26 may prompt the user upon determining that the sequence of movement detected at step 206 does not match one of the characters in the font set. Alternatively, the user may be able to select between a markup and an insert from a menu. The menu may include a default choice between the two. After the representation has been entered in the electronic image, the user may be able to scale the size of the entered representation relative to the contents of the electronic image and/or move the entered representation within the electronic image. In one embodiment, the user can scale the size of the entered representation by placing one finger 40 at each of two opposite corners of the image and then moving the two fingers 40 toward each other to shrink the entered representation or away from each other to enlarge the entered representation. In this embodiment, the user can move the entered representation by placing one finger 40 on the entered representation and performing a swipe to move the entered representation to its desired location within the electronic image being edited.

If, at step 202, the first predetermined continuous arrangement is not detected but the second predetermined continuous arrangement is detected at step 203, the user may perform additional operations in the electronic image by entering predetermined touch inputs at step 209. In one embodiment, processor 26 determines at step 210 whether the touch input is a swipe. If the touch input is a swipe, at step 211, the view of the electronic image is adjusted according to the user's input. For example, a two finger swipe may be used to provide a zoom function. A one finger swipe may be used to pan up, down, left or right within the electronic image in order to view a different portion of the image. If the touch input is not a swipe, processor 26 will reposition the cursor of the electronic image to the position of the touch input at step 212. In one embodiment, the user may also activate a menu by placing his or her fingers 40 on touch screen display 22 according to a third predetermined continuous arrangement. For example, where the first predetermined continuous finger arrangement consists of the substantially stationary presence of two non-thumb fingers 40A of one of the user's hands 42A, 42B on touch screen display 22, the user may activate a menu by placing three fingers 40 of his or her other hand on touch screen display 22. The menu may contain various options such as font type, font color, font size, font style, or selections for any other user preference.

In one embodiment, computing system 20 may also be used for biometric to identification. For example, computing system 20 may identify a user by requesting the user to place all or a portion of his or her hand on touch screen display 22. Computing system 20 may also identify a user by requesting the user to enter his or her signature in the form of swipes on touch screen display 22. Processor 26 may then compare the user's hand and/or signature to an image previously associated with the user to verify his or her identity.

The foregoing description of several embodiments has been presented for purposes of illustration. It is not intended to be exhaustive or to limit the application to the precise forms disclosed, and obviously many modifications and variations are possible in light of the above teaching. It is understood that the invention may be practiced in ways other than as specifically set forth herein without departing from the scope of the invention. It is intended that the scope of the application be defined by the claims appended hereto.

What is claimed is:

1. A method for providing a touch screen keyboard, comprising:
detecting the presence of a user's fingers on a touch screen display;
associating a set of home keys of a keyboard with the detected fingers; and
displaying the keyboard on the touch screen display with the home keys positioned at the locations of the detected fingers and additional keys positioned relative to the home keys.

2. The method of claim 1, further comprising:
distinguishing between a tap and a resting presence of one of the user's fingers on the touch screen display;
interpreting the tap of one of the user's fingers on one of the home keys or one of the additional keys as a key stroke and recording a key entry in an electronic image being edited; and
interpreting the resting presence of one of the user's fingers on one of the home keys as a return to the home key and not recording a key entry in the electronic image.

3. The method of claim 2, further comprising:
detecting whether the location of the resting presence of one of the user's fingers differs from the position of the associated home key; and
when the location of the resting presence of the user's finger differs from the position of the associated home key, repositioning the associated home key to the location of the user's finger.

4. The method of claim 2, further comprising distinguishing a moving presence of one of the user's fingers on the touch screen display from the tap or the resting presence and adjusting the view of the electronic image upon detecting the moving presence of one of the user's fingers on the touch screen display.

5. The method of claim 2, further comprising hiding the keyboard display, continuing to associate the home keys with the detected fingers, continuing to interpret the tap of one of the user's fingers on one of the home keys or one of the additional keys as the key stroke, and continuing to interpret the resting presence of one of the user's fingers on one of the home keys as the return to the home key.

6. The method of claim 2, further comprising determining a key entry corresponding to one of the additional keys by detecting the removal of one of the user's fingers from the associated home key and the presence of one of the user's fingers on the additional key.

7. The method of claim 1, further comprising:
instructing the user to perform a predetermined sequence of key strokes on the keyboard that includes a plurality of the additional keys;
detecting the locations of the performed key strokes for the additional keys; and
adjusting the positions of the additional keys based on the detected locations and associating the adjusted positions of the additional keys with a user profile for the user.

8. The method of claim 1, further comprising:
detecting a key stroke of a first of the additional keys and recording a corresponding key entry;
detecting a replacement of the key entry by the user with a second of the additional keys that abuts the first of the additional keys; and
adjusting the position of at least one of the first and second of the additional keys so that the second of the additional keys corresponds with the location of the key stroke and associating the adjusted position with a user profile for the user.

9. The method of claim 1, wherein the displayed keyboard is transparently overlaid on an electronic image being edited.

10. The method of claim 1, wherein the sizes of the home keys and the additional keys depend on the spacing between the home keys.

11. The method of claim 1, wherein the spacing of the additional keys relative to the home keys depends on the spacing between the home keys.

12. The method of claim 1, further comprising:
detecting whether at least a predetermined number of the user's fingers are swiped across and off the touch screen display; and
when at least the predetermined number of the user's fingers are swiped across and off the touch screen display, deactivating and removing the displayed keyboard.

13. The method of claim 1, wherein the display of at least one of the home keys and the additional keys matches at least one of a font type and a font color selected by the user for use in an electronic image being edited.

14. The method of claim 1, further comprising activating and displaying the keyboard upon detecting the presence of at least seven of the user's fingers on the touch screen display.

15. A computing system, comprising:
a touch screen display for receiving touch inputs from a user and displaying images thereon;
at least one processor communicatively coupled to said touch screen display; and
memory having computer executable program instructions stored therein to be executed by the at least one processor, including:
instructions for detecting the presence of the user's fingers on the touch screen display;
instructions for associating a set of home keys of a keyboard with the detected fingers; and
instructions for displaying the keyboard on the touch screen display with the home keys positioned at the locations of the detected fingers and additional keys positioned relative to the home keys.

16. The computing system of claim 15, further comprising
instructions for distinguishing between a tap and a resting presence of one of the user's fingers on the touch screen display;
instructions for interpreting the tap of one of the user's fingers on one of the home keys or one of the additional keys as a key stroke and recording a key entry in an electronic image being edited; and
instructions for interpreting the resting presence of one of the user's fingers on one of the home keys as a return to the home key and not recording a key entry in the electronic image.

17. The computing system of claim 16, further comprising:
instructions for detecting whether the location of the resting presence of one of the user's fingers differs from the position of the associated home key; and
instructions for repositioning the associated home key to the location of the user's finger when the location of the resting presence of the user's finger differs from the position of the associated home key.

18. The computing system of claim 15, further comprising:
instructions for detecting whether at least a predetermined number of the user's fingers are swiped across and off the touch screen display; and
instructions for deactivating and removing the displayed keyboard when at least the predetermined number of the user's fingers are swiped across and off the touch screen display.

19. The computing system of claim 15, wherein the sizes of the home keys and the additional keys depend on the spacing between the home keys.

20. The computing system of claim 15, wherein the spacing of the additional keys relative to the home keys depends on the spacing between the home keys.

21. The computing system of claim 15, further comprising instructions for activating and displaying the keyboard upon detecting the presence of at least seven of the user's fingers on the touch screen display.

22. A non-transitory computer readable storage medium having computer executable program instructions which, when executed by a computing system having a touch screen display, cause the system to:
detect the presence of a user's fingers on the touch screen display;
associate a set of home keys of a keyboard with the detected fingers; and
display the keyboard on the touch screen display with the home keys positioned at the locations of the detected fingers and additional keys positioned relative to the home keys.

23. The non-transitory computer readable storage medium of claim 22, wherein the computer executable storage instructions, when executed by the computing system, cause the system to:
distinguish between a tap and a resting presence of one of the user's fingers on the touch screen display;
interpret the tap of one of the user's fingers on one of the home keys or one of the additional keys as a key stroke and record a key entry in an electronic image being edited; and
interpret the resting presence of one of the user's fingers on one of the home keys as a return to the home key and not record a key entry in the electronic image.
